(19) United States
(12) Patent Application Publication
(10) Pub. No.: US 2011/0197918 A1
(43) Pub. Date: Aug. 18, 2011

(54) APPARATUS AND METHOD FOR CLEANING RUBBER BLANKETS ON BLANKET CYLINDERS

(76) Inventor: Michael Kasper, Monchengladbach (DE)

(21) Appl. No.: 13/124,992

(22) PCT Filed: Oct. 14, 2009
(86) PCT No.: PCT/DE2009/001432

§ 371 Date: Apr. 19, 2011

Related U.S. Application Data
(60) Provisional application No. 61/162,807, filed on Mar. 24, 2009.

(30) Foreign Application Priority Data
Oct. 26, 2008 (DE) 10 2008 053 118.9

(51) Int. Cl. B08B 1/00; B21B 45/02

(52) U.S. Cl. 134/6; 15/256.5

(57) ABSTRACT

The invention relates to an apparatus for cleaning the rubber blanket stretched over a rubber blanket cylinder (1) of a printing press, using a cleaning apparatus, characterized in that the cleaning apparatus comprises at least one moving and transporting apparatus (6), at least two cleaning modules (2) which are connected to each other, at least one cleaning cloth winding reel (4), and at least one cleaning cloth supply reel (3), wherein the moving and transporting apparatus (6) is designed such that it can move the cleaning modules (2) connected to each other parallel to the axis of the rubber blanket cylinder (1), and the moving and transporting apparatus (6) is furthermore designed such that it transports a cleaning cloth provided on the cleaning cloth supply reel (3) onto the cleaning cloth winding reel (4) by way of the cleaning modules (2).

The present invention relates to an apparatus for cleaning rubber blankets on blanket cylinders.

Offset printing represents the most widespread printing process. Offset printing is a high quality planographic printing process, in which printing is carried out indirectly from a printing plate via a rubber blanket as intermediate carrier onto the respective printing material, for example paper. In terms of its basic construction, an offset printing press can comprise three cylinders: the plate cylinder, the blanket cylinder and the impression cylinder. In principle, a printing operation can proceed as follows: the printing plate which is clamped on the plate cylinder accepts grease containing printing ink at their printing locations. The nonprinting locations accept water. Since those locations of the printing plate which carry images and are free of images lie in one plane, this method is also called a planographic printing process. The plate then transfers the right reading printing image in a reverse reading manner onto the rubber blanket which is clamped on the blanket cylinder. Said rubber blanket transmits the still reverse reading image onto the paper which runs through between the impression cylinder and the blanket cylinder and on which it then appears right reading again as a printed image.

The application of ink onto the rubber blanket which is clamped on the blanket cylinder makes it necessary to clean the rubber blanket, since various impurities accumulate on the rubber blanket during continuous printing precisely in the case of the offset process. Not only ink and ink residues are therefore to be found there, but also fibers, dust, sand, dirt and the like which have to be removed, in order to maintain the print quality. Cleaning of the rubber blankets is necessary at least after each print job, simply in order to remove the printing image which is still present. However, cleaning operations are also necessary during a work process if the latter is correspondingly complicated. Furthermore, further cleaning operations are also required during the preparation for a new print job. However, this means that the machine has to be stopped every time during the cleaning duration.

The previously customary, manual cleaning has been widely replaced in the meantime by automatic and semiautomatic rubber blanket washing systems, as are known in the prior art. They can be divided into two categories according to the type of cleaning, namely the cleaning of the rubber blanket with the aid of a cleaning cloth or cleaning nonwoven, as described, for example, in patent document DE 102 307 90 C2 and its more broadly worded laid open specification of DE 102 307 90 AI, filed by Grafotec Kotterer GmbH from Diedorf, or else the cleaning of the rubber blanket with the aid of a brush.

Recently, however, new printing presses can be obtained on the market, which now have considerably longer axles in the respective cylinders. Said printing presses are now capable of outputting, that is to say printing, a wider printing image onto the printing material which is running through, as a rule paper, during one revolution of the blanket cylinder. However, the issue is not only the printing of wider images, but also an increase in the printing capacity and printing speed. If, for instance, a plurality of images are arranged next to one another, or if a plurality of pages are produced next to one another on the paper to be printed, as in newspaper printing, in order to be trimmed later to the usual format again, even more pages can then be printed next to one another in the case of a greater printing width, with the result that more paper can be printed at the same printing running speed.

However, even in the case of the use of rubber blanket cleaning systems according to the prior art, the longer axial cylinders necessarily entail a wider rubber blanket to be clamped and therefore of course also a greater surface area to be cleaned, that is to say a widened surface area. Attempts to likewise adapt the size of the rubber blanket washing systems to the rubber blanket dimensions to be cleaned have many disadvantages, however. It is therefore absolutely necessary at certain time intervals to remove the rubber blanket washing apparatus from the printing press, in order to clean it for its part, since the accumulated ink residues, the dirt and the other abovementioned impurities can clog in the mechanism or other components of the washing and cleaning apparatus and therefore damage the latter over time. Even in the case of repair work on the rubber blanket washing system or the cleaning apparatus itself, they have to be removed from the printing press in some circumstances. Furthermore, other work operations on the printing press which do not relate to the cleaning apparatus likewise require the removal of the cleaning apparatus. On account of its size (this can be an axial length of 450 cm or even longer) and its weight, the dismantling of the cleaning apparatus requires the use of a plurality of people and in all cases results in the interruption of the printing operation. (The case is to be considered where the printing press has to print day and night in the case of a particularly urgent and important job. A down time of the printing press in this period can lead to great problems in finishing the job on time.) The size, lack of handleability and weight of the cleaning apparatus can therefore destroy the advantage of the higher printing speed.

Further disadvantages which relate, however, only to the rubber blanket cleaning apparatuses which operate with the aid of a cleaning cloth are caused in the production of said cleaning cloth. A cleaning cloth of this type usually comprises a high quality nonwoven substance which has also partially been immersed in a solvent for the cleaning operation or has been sprayed with a solvent. In order that said cleaning cloth can withstand the enormous mechanical loadings which occur of the unwinding and rewinding before and after the cleaning operation and additionally the pronounced mechanical loading which is produced by pressing the cleaning cloth onto the rubber blanket, it has to have a defined tensile strength. The desired tensile strength is achieved by material thickening or a targeted material reinforcement. This is because damp cloths which are usually used for cleaning normally do not withstand such high tensile forces, with the result that cloths for this purpose have to comprise a material which can be loaded particularly and has particular tensile strength. However, the production of said cleaning cloths from a nonwoven substance which can be loaded and has tensile strength leaves traces in the form of what are known as “tracks” on the cloths. Said tracks can comprise thickened or thinned cleaning cloth material and extend over the entire length of the cloth, to be precise usually parallel to the side walls. If a cleaning cloth of this type which has “tracks” is then used during the cleaning operation, it always presses on a specific location of the rubber blanket. The cleaning cloth leaves traces there in the form of lines and dents which for their part are situated parallel to the side edges of the rubber blanket but also lead around the entire cylinder, that is to say pervade the entire rubber blanket. Said lines and dents are also transferred to the paper during the printing operation and are found on the printed image in the embossing of stripes and, as a result, have a negative influence on the quality of the printed product.

It is also very complicated and expensive technically to produce cleaning cloths in this width and then transport them to their actual location of use. Completely new fabrication and cutting machines have to be constructed and built for large formats of this type, it not being certain that said machines can guarantee the currently necessary quality over the complete width and length of the cloth. The transport and storage costs are also considerably higher in “oversizes” of this type in comparison with the commercially available sizes.

Another disadvantage which results from the increased length of the blanket cylinder axle is the lower and nonconstant contact pressure of the cleaning apparatus on the rubber blanket along the axles. The cleaning cloth and the rubber blanket are clamped on cylinders which lie with their axles parallel to one another, the cleaning cloth being pressed onto the rubber blanket. On account of mechanical manufacturing inaccuracies in the material production and the inherent material weakness which increases more and more over the service life of the apparatuses, there are locations at which the cleaning cloth does not press on the rubber blanket so firmly. As a consequence of this different contact pressure, said locations are cleaned less carefully. The longer the axles are, the greater the differences in the contact pressure which occur along said axles. This in turn leads to a poorer print quality and can be eliminated only supplementary manual cleaning work. As is known, this is very expensive as a result of the personnel costs and additionally also time intensive, since the printing press cannot print during this cleaning time.

It is therefore an object of the present invention to specify an apparatus which ensures the cleaning of the rubber blankets on blanket cylinders in an expensive and time saving manner, it being possible firstly for the blanket cylinders to have a very long axle, and which apparatus also avoids the formation of stripes on the rubber blanket by the cleaning cloth. In addition, the present invention is to avoid the further abovementioned disadvantages.

According to the invention, this object is achieved by an apparatus for cleaning the rubber blanket which is clamped on a blanket cylinder of a printing press, which apparatus is distinguished by the fact that the cleaning apparatus has at least one movement and transport apparatus, at least two cleaning modules which are connected to one another, at least one cleaning cloth rewinding reel and at least one cleaning cloth supply reel, the movement and transport apparatus being set up in such a way that it moves the cleaning modules which are connected to one another parallel to the axis of the blanket cylinder, and the movement and transport apparatus being set up, furthermore, in such a way that it transports a cleaning cloth which is provided on the cleaning cloth supply reel via the cleaning modules to the cleaning cloth rewinding reel.

The movement and transport apparatus ensures, inter alfa, not only the transport of the cleaning cloth from the cleaning cloth supply reels past the rubber blanket to the cleaning cloth rewinding reel, but it is also responsible for the movement of the cleaning modules, approximately parallel to the blanket cylinder axle. However, the movement of the cleaning modules which is parallel to the axle does not preclude a further movement direction of the cleaning modules. The cleaning modules also do not have to be moved in an uninterrupted manner during the entire cleaning operation; they can even be at a standstill for a time or can even be at a standstill during the entire cleaning time period.

The cleaning cloth supply reel accommodates the supplies of fresh unused cleaning cloth; the cleaning cloth rewinding reel receives the cleaning cloth which is contaminated by the cleaning operation.

In the context of this application, a cleaning module is a module which also has the object of pressing a cleaning cloth onto the rubber blanket. Here, the pressure is likewise of significance. In this operation, the cleaning cloth can be dry, moistened with water or a cleaning chemical, or it can also be treated in a different way. However, it goes without saying that it should be suitable for cleaning the rubber blanket. The cleaning of the rubber blanket can be assisted and/or carried out by movement of the cleaning cloth on the rubber blanket surface. This movement of the cleaning cloth with respect to the rubber blanket surface can be composed firstly by the rotation of the blanket cylinder about its own axis and by movement of a part of the cleaning module or else of the entire cleaning module. It goes without saying that these two types of movement also supplement and assist one another during the cleaning work.

In a cleaning apparatus of this type according to the invention, the cleaning work of the rubber blankets on blanket cylinders is divided up to a plurality of relatively small cleaning modules. In the simplest case, said cleaning modules are cylindrical, the cleaning cloth being guided over the cylindrical roller (sleeve) and in the process being pressed onto the rubber blanket. This cylindrical sleeve can then also have the known apparatuses for optimizing the contact pressure of the cloth on the rubber blanket. An inflatable rubber ring is thus known here which is fed by compressed air. All other known pressing apparatuses can likewise be used, however. The length of the cylindrical reel in the apparatus according to the invention is not as long, however, as the overall length of the rubber blanket axle, with the result that a plurality of said cleaning modules are advantageously connected to one another, in order to clean the rubber blanket completely on its entire axial length of the blanket cylinder. To this end, a plurality of said cleaning modules are connected to one another, for example linearly (in a straight line behind one another), with the result that one end of a cleaning module is connected to the start of the respective neighbor via a connecting means. Conventional and known mechanical connecting pieces are suitable here as connecting means between the modules, such as simple screw connections, plug in or bayonet connections. Every other possible connection for the cleaning modules is also conceivable in turn and can usually be installed readily into the cleaning apparatus. They simply have to be suitable for satisfying the mechanical requirements of the cleaning process.

Since no sizes are necessarily required for the cleaning modules, they can be produced precisely in the desired size and installed into the respective printing presses. As a result, their size can be adapted to the usual formats of the respective cleaning cloths or the respective printing formats or page formats. Since high quality cloth, that is to say also the cleaning nonwoven, is not produced in all sizes, the use of said high quality cloth can be ensured by the selection of a cleaning module having a certain size. If a less expensive cloth is sufficient for the current cleaning work, and this can be obtained only in a certain cut size, the size of the cleaning module can then be adapted to the format of said cloth. Furthermore, the smaller axial length of the cleaning modules also leads to a more uniform contact pressure on the rubber blanket along the axle of the cleaning modules. The contact pressure can therefore be set in an optimum manner for the cleaning work.

The connecting bridges between the cleaning modules which do not have to comprise solely the connecting means are then not capable of cleaning the rubber blanket, with the result that uncleaned vertically extending areas would be left behind on the rubber blanket. In order that this does not happen, the cleaning modules are moved to and fro on the rubber blanket parallel to the blanket cylinder axle with the aid of the movement and transport apparatus. This movement ensures the cleaning of the otherwise uncleaned areas between the cleaning modules. However, it also represents an improvement in the cleaning quality, since, under the contact pressure, with which the cleaning module presses onto the rubber blanket, the movement of the cleaning cloth assists the release even of impurities which are difficult to remove. In the case of cleaning according to the prior art, although the cleaning cloth wipes over the rubber blanket with a certain pressure, it does so always only in one direction. In the case of the cleaning operation with the aid of the apparatus according to the invention, the rubber blanket is wiped not only in the rotational direction of the axle of the blanket cylinder, but also parallel to it. As a result of this movement, the forces then act on the impurities to be removed from different directions. As a result, they can be released from the blanket more easily.

In addition, the movement of the cleaning modules also prevents the formation of stripes by the “tracks” on the cleaning cloths, since the “tracks” do not then act permanently on the same locations of the rubber blanket and cannot leave their traces there. This increases the printing quality and the service life of the rubber blanket considerably, which leads to lower operating costs. A higher production capacity of the printed products is also achieved by the omission of the repair time which is necessary for changing the rubber blanket.

In a further embodiment of the invention, the apparatus for cleaning the rubber blanket is set up in such a way that the movement and transport apparatus move the cleaning modules which are connected to one another, in such a way that the cleaning cloth which runs via the cleaning modules makes contact with the entire width and the entire length of the rubber blanket. When contact is made with the rubber blanket, it is of course also cleaned, with the result that the entire surface of the rubber blanket is cleaned. Depending on the setting of the movement and transport apparatus, some locations of the rubber blanket surface are even cleaned by more than one cleaning module, since the movement paths of the cleaning modules can overlap. In this case, a more effective cleaning operation can therefore also be assumed.

This embodiment of the invention ensures that the entire area of the rubber blanket is also covered by the cleaning cloth during one revolution and in the best case is even cleaned completely. This can be effected, for example, by synchronization which stipulates the standstill time of the blanket cylinder. The cleaning modules move to and from on the stationary rubber blanket. After a certain freely adjustable time period, the rubber blanket is moved a little by rotation of the blanket cylinder, with the result that a new location can be cleaned. After one complete revolution of the blanket cylinder, the entire rubber blanket can therefore be cleaned in the ideal case. At certain, likewise freely adjustable time intervals, the cleaning cloth is likewise transported further by the movement and transport apparatus, that is to say unrolled from the supply reel and rewound onto the rewinding reel. Renewed contamination of the rubber blanket as a result of an already contaminated cleaning cloth can thus be avoided. Complete cleaning of the rubber blanket can also be achieved by virtue of the fact that the to and fro movement of the cleaning cloth is carried out by means of the cleaning modules at a defined speed. In this case, the rubber blanket can even be moved further continuously by a continuous rotation of the blanket cylinder; no synchronization is therefore necessary to determine the rubber blanket standstill.

In a further preferred embodiment of the present invention, the connecting bridges which connect the cleaning modules to one another are flexible per se. In the context of this application, flexibility of the connecting bridges means that it is possible to bend the connecting bridges into themselves, to lengthen them or to shorten them, without damaging them or impairing their function in some way. This allows changing of the arrangement of the cleaning modules with respect to one another. In the simplest case, they are arranged linearly next to one another. However, it is then also possible to displace one cleaning module to the rear. Depending on the setting of the movement of the cleaning modules on the rubber blanket, the rubber blanket is then cleaned particularly thoroughly at some locations, since said locations are wiped multiple times by different cleaning modules.

In another embodiment of the present invention, the contamination of the cleaning cloth and/or the contamination of the rubber blanket are/is measured with the aid of a measuring unit. This embodiment is intended to ensure the quality of the cleaning is at a defined level. In this embodiment according to the invention, the rubber blanket is rotated further only after a successful cleaning operation. The determination of when a cleaning operation is denoted as successful is made with the aid of a measuring unit. A measuring unit of this type can react, for example, to the color of the rubber blanket or to the color of the cleaning cloth and release the further movement of the blanket cylinder only when the original color of the rubber blanket is detected or the original color of the cleaning cloth is no longer detected. In the first case, the rubber blanket is cleaned until the measuring unit detects the color of the rubber blanket to be the original. In the second case, the contamination of the cleaning cloth is considered as criterion for the degree of cleaning of the rubber blanket. Since the cleaning cloth is always rotated further periodically, a clean cleaning cloth will wipe the cleaned rubber blanket at some point. This is precisely the moment, at which the blanket cylinder is rotated further and rubber blanket which has not yet been cleaned takes the place of the cleaned rubber blanket. Since the term “cleaned” is not meaningful for a measuring unit, the measuring unit is calibrated in such a way that defined achieved freely selectable measured values represent this term “cleaned” and then release the rotation of the blanket cylinder. These embodiments of the invention then ensure very thorough cleaning work which could be carried out, for example, after every terminated print job, since in this case the rubber blanket has to be returned to its original state, in order to be ready for the new following print job without disruptive residues on the rubber blanket.

In one particularly preferred embodiment, the invention according to the invention is constructed in such a way that the cleaning modules are attached at the same level horizontally with respect to one another. This embodiment represents only one possibility of the arrangement for the cleaning modules. However, it can be realized simply in technical terms and has very favorable costs as a result. In this case, the connecting bridges form a straight line between the individual cleaning modules. The cleaning line, that is to say the line, in which the cleaning of the rubber blanket advances, extends rectilinearly in this embodiment and at an approximate right angle to the side edges.

In a further embodiment, the cleaning modules are not attached at the same level horizontally with respect to one another. In this case, the cleaning line does not extend in a straight line at a right angle with respect to the side edges of the rubber blanket.

A further preferred embodiment of the apparatus for cleaning the rubber blanket is distinguished by the fact that the cleaning modules move not only parallel to the blanket cylinder axle, but can also perform up and down movements on the surface of the rubber blanket. Just the movement of the cleaning modules ensures a greater cleaning effect of the rubber blanket. The additional up and down movements on the rubber blanket increase the cleaning performance additionally. The cleaning cloth “attacks” the ink residues from almost all directions, namely not only from the right and left, but then also from above and below, and as a consequence also finds new attacking points in order to detach the ink residues from the rubber blanket. Although this embodiment of the invention represents a technically more complex construction of the movement and transport apparatus, the result justifies this complexity completely.

This is equally true of the likewise very preferred embodiment, in which the cleaning modules then even perform circular or ellipsoidal movements on the rubber blanket surface. In these two last embodiments, the cleaning modules “scrub” the rubber blanket. In combination with the cleaning cloths which have already been premoistened and are known in the prior art and the cleaning cloths which are moistened by nozzles, a very high cleaning quality can be achieved. Other possibilities which are known in the prior art for improving the cleaning quality of the cleaning cloth can likewise be used in the present invention.

In one particularly special embodiment of the present invention, a further cleaning module is not attached at the same horizontal level as the other cleaning modules which lie horizontally at the same level with respect to one another.

In this embodiment, the further cleaning module can smooth and therefore remove the stripes which are possibly still present on the rubber blanket. This is necessary when a cleaning cloth has been used to clean the rubber blanket, which cleaning cloth has loaded the rubber blanket to a pronounced extent in this respect, that is to say a cloth which has the above-described “tracks”.

In the case where certain locations on the rubber blanket are loaded to a particularly pronounced extent in the current print job, it is then possible to set a cleaning module, for instance the additional cleaning module, in such a way that the locations on the rubber blanket which are loaded to a particularly pronounced extent and are therefore particularly contaminated are cleaned multiple times, but at least twice, during one revolution of the blanket cylinder. It goes without saying that further cleaning modules can likewise be set in a freely selectable manner. For instance, a plurality of locations can be cleaned multiple times in the case of particularly wide rubber blankets.

In one particularly special embodiment of the present invention, the apparatus for cleaning the rubber blanket is set up in such a way that the contact pressure of the cleaning modules on the rubber blanket can be set freely. This means that a dedicated contact pressure can be set for each cleaning module. If certain locations of the rubber blanket are cleaned by a plurality of cleaning modules, the first cleaning module can perform precleaning as a result of targeted setting of the contact pressure, while the further cleaning modules perform postcleaning or smoothing of the lines and dents. The advantage of this embodiment is obvious—firstly the cleaning quality is increased, and secondly the rubber blanket is treated with care and can thus be used for a longer time.

In one completely different embodiment of the present invention, the movement of the cleaning modules is synchronized in such a way that they move to and fro synchronously, to be precise in each case in the same direction, or else the movement of the cleaning modules extends toward one another or away from one another. If more than two cleaning modules are provided for cleaning, at least two of the cleaning modules move toward one another or away from one another.

In another embodiment of the present invention, the cleaning modules can be controlled individually, that is to say their movement on the rubber blanket can be controlled in each case individually.

In one completely different embodiment of the present cleaning apparatus, the cleaning modules are set up in such a way that the cleaning cloths can be treated by an apparatus which is attached there. Individual moistening by way of in each case different cleaning agents is conceivable here. Thus, for example, the front cleaning modules can apply “hard” cleaning agents (chemicals with a pronounced action) to the cleaning cloths, but the rear cleaning modules moisten their cleaning cloth with water.

In a further embodiment, the apparatus, in particular its transport and movement device, is controlled electronically and/or pneumatically. This in no way rules out another type of control or regulation of the cleaning device overall or its individual modules or part devices.

The apparatus for cleaning the rubber blanket which is clamped onto a blanket cylinder of a printing press can be assembled, rebuilt, serviced and in the case of damage repaired as a result of its construction by means of individual modules. The cleaning modules can be exchanged, even their sizes can be changed, since the connecting bridges are flexible per se.

Further exemplary embodiments can be gathered from the individual different elements described in the preceding text of the present apparatus.

In the following text, exemplary embodiments of the present invention which are not to be understood restrictively are discussed using the drawing, in which:

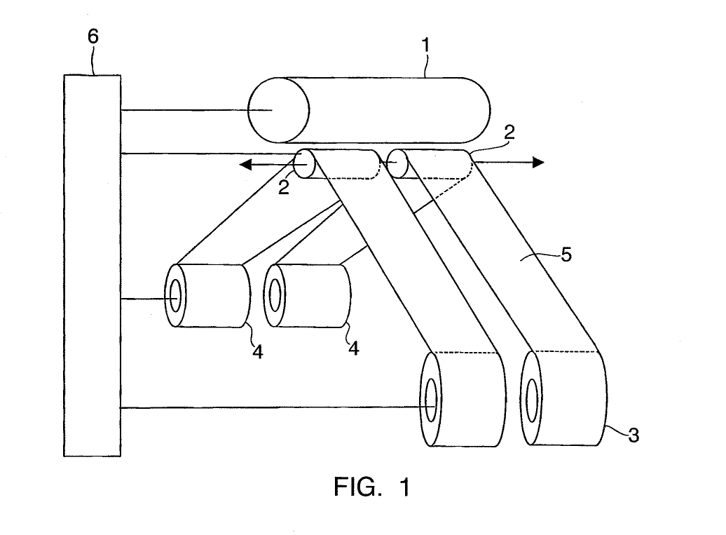

FIG. 1 diagrammatically shows an apparatus according to the invention for cleaning a rubber blanket;

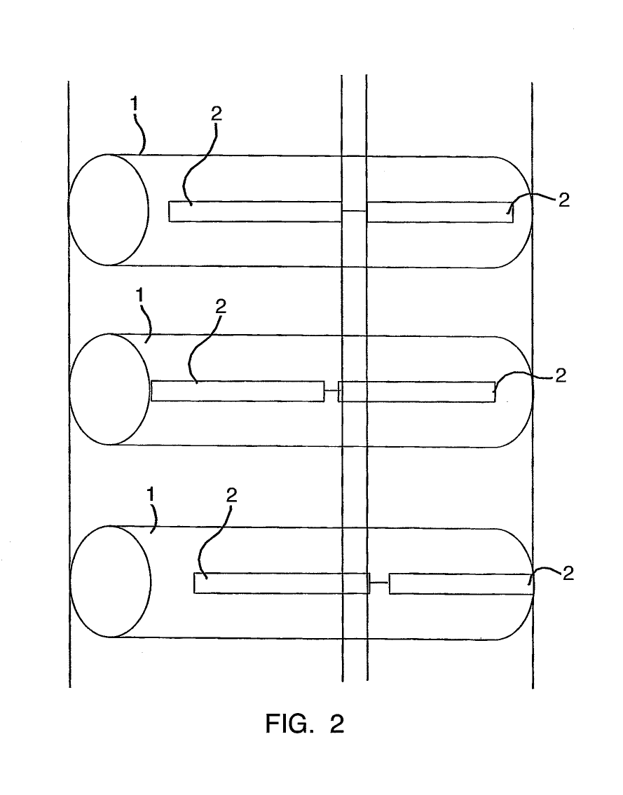

FIG. 2 diagrammatically shows a rubber blanket with cleaning modules and their range in the movement; and

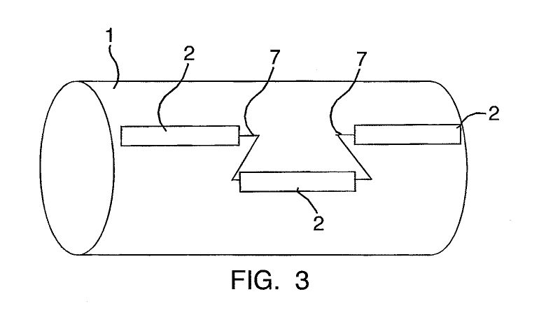

FIG. 3 diagrammatically shows a rubber blanket with cleaning modules and the flexible connecting bridges.

FIG. 1 diagrammatically shows an apparatus according to the invention for cleaning a rubber blanket.

Here, the blanket cylinder 1 with the clamped rubber blanket, and the cleaning modules 2 which are connected to one another, the cleaning cloth supply reel 3, the cleaning cloth rewinding reel 4 and the cleaning cloth 5 can be seen readily. The movement and transport device 6 is not shown in detail in FIG. 1, the lines to the blanket cylinder 1, to the cleaning modules 2 which are connected to one another, to the cleaning cloth supply reel 3 and to the cleaning cloth rewinding reel 4 representing the attachment to the transport and movement device, it also being a part thereof. The cleaning cloth is unwound from the supply reel 3, guided via the cleaning modules 2, pressed onto the rubber blanket there with a defined contact pressure and subsequently guided again to the cleaning cloth rewinding reel 4, where the contaminated cloth is wound up, in order then to be disposed of. The arrows show the movement direction, in which the cleaning modules 2 can be moved to and fro. This sideways movement of the cleaning modules 2 in combination with the movement of the rubber blanket about the blanket cylinder axle is already sufficient in most cases for thorough cleaning of the rubber blanket.

FIG. 2 diagrammatically shows the rubber blanket which is clamped onto the blanket cylinder 1, with two cleaning modules 2 and their range during the movement. The cleaning modules 2 which are connected to one another lie on the rubber blanket and are pressed onto the rubber blanket there with a defined freely adjustable contact pressure. A gap which would not be cleaned without the sideways movement of the cleaning modules exists between the two cleaning modules 2 which are connected to one another by a connecting bridge. The size of the cleaning modules 2 and the spacings of them from one another and from the edge of the rubber blanket have to be well defined, since otherwise uncleaned locations on the rubber blanket can occur. In most printing presses, the cleaning module 2 cannot move out beyond the edge of the rubber blanket without disrupting the running operation of the printing press. The cleaning module 2 therefore stops approximately at the outer edge of the rubber blanket. It is then important that, in the case of a movement to the right of the modules 2, the left cleaning module 2 cleans that location on the rubber blanket which cannot be reached by the right cleaning module 2. The same is true of the movement to the left of the cleaning modules 2. In present FIG. 2, the gap between the cleaning modules is identified by two straight lines. In this example, said locations are even cleaned twice, namely by the right and by the left cleaning module 2. As a result, the entire rubber blanket is cleaned, in particular, in its width. Conventional large formats for the mother reels, from which the cleaning cloth is cut, are 3.81 m or 2.98 m. The production and also the transport of larger mother reels require some complexity and are very expensive. Conventional formats, in which the length of the impression rolls and therefore also of the blanket cylinders are to be calculated as an integral or approximately as a multiple, are as follows:

For the Rhine format: 35×51 cm, the impression cylinder has a width of 140 cm, with the result that 4×35 pages of this type can be printed next to one another in the stated formats. This is the state of the art and can be widened in these formats in each case by the width of a further 35 cm.

Large formats lie in a range of 570 mm×400 mm (Nordic format), 510 mm×350 mm (Rhine format).

FIG. 3 diagrammatically shows the rubber blanket with cleaning modules 2 and the flexible connecting bridges 7. It can be seen clearly in this figure that the cleaning modules can stand not only in a row horizontally with respect to one another, but they can also be offset with respect to one another. This can bring about multiple cleaning of locations on the rubber blanket which are particularly contaminated by the printing operation. Furthermore, the cleaning module which is then situated behind the others can smooth the locations which are pressed in by the “tracks” of the cleaning cloth.

What is claimed is:

1. Apparatus for cleaning the rubber blanket which is clamped on a blanket cylinder (1) of a printing press, characterized in that
the cleaning apparatus has at least one movement and transport apparatus (6), at least two cleaning modules (2) which are connected to one another, at least one cleaning cloth rewinding reel (4) and at least one cleaning cloth supply reel (3),
the movement and transport apparatus (6) being set up in such a way that it moves the cleaning modules (2) which are connected to one another parallel to the axis of the blanket cylinder (1), and
the movement and transport apparatus (6) being set up, furthermore, in such a way that it transports a cleaning cloth (5) which is provided on the cleaning cloth supply reel (3) via the cleaning modules (2) to the cleaning cloth rewinding reel (4).

2. Apparatus for cleaning the rubber blanket according to claim 1, characterized in that the movement and transport apparatus (6) moves the cleaning modules (2) which are connected to one another, in such a way that the cleaning cloth (5) which runs via the cleaning modules (2) makes contact with the entire width and the entire length of the rubber blanket.

3. Apparatus for cleaning the rubber blanket according to claim 1, characterized in that connecting bridges (7) which connect the cleaning modules (2) to one another are flexible per se.

4. Apparatus for cleaning the rubber blanket according to claim 1, characterized in that the contamination of the cleaning cloth (5) is measured with the aid of a measuring unit and, during the cleaning operation, the rubber blanket is rotated further only after a defined measured value is reached.

5. Apparatus for cleaning the rubber blanket according to claim 1, characterized in that the contamination of the rubber blanket is measured with the aid of a measuring unit and, during the cleaning operation, the rubber blanket is rotated further only after a defined measured value is reached.

6. Apparatus for cleaning the rubber blanket according to claim 1, characterized in that the cleaning modules (2) are attached at the same level horizontally with respect to one another.

7. Apparatus for cleaning the rubber blanket according to claim 1, characterized in that the cleaning modules (2) are attached at a non-identical level horizontally with respect to one another.

8. Apparatus for cleaning the rubber blanket according to claim 1, characterized in that the cleaning modules (2) move not only parallel to the blanket cylinder axle, but also perform up and down movements on the surface of the rubber blanket.

9. Apparatus for cleaning the rubber blanket according to claim 1, characterized in that the cleaning modules (2) perform circular and/or ellipsoidal movements on the surface of the rubber blanket.

10. Apparatus for cleaning the rubber blanket 5 according to claim 6, characterized in that at least one further cleaning module (2) is not attached at the same level horizontally as the remaining cleaning modules (2).

11. Apparatus for cleaning the rubber blanket according to claim 1, characterized in that the contact pressure can be set individually at each cleaning module (2).

12. Apparatus for cleaning the rubber blanket according to claim 1, characterized in that the movement of the cleaning modules (2) is synchronized in such a way that at least two of the cleaning modules (2) move to and fro on the rubber blanket in the same direction in relation to one another.

13. Apparatus for cleaning the rubber blanket according to claim 1, characterized in that the movement of the cleaning modules (2) is synchronized in such a way that at least two of the cleaning modules (2) move on the rubber blanket towards one another or away from one another in relation to one another.

14. Apparatus for cleaning the rubber blanket according to claim 1, characterized in that the cleaning modules (2) can be moved individually.

15. Apparatus for cleaning the rubber blanket according to claim 1 characterized in that the cleaning modules (2) are set up in such a way that the cleaning cloths can be treated individually.

16. Apparatus for cleaning the rubber blanket according to claim 1, characterized in that the transport and movement device (2) is controlled electronically and/or pneumatically.

17. Method for cleaning a rubber blanket which is clamped on a blanket cylinder of a printing press, characterized in that an apparatus according to claim 1 is used.
